(19) United States
(12) Patent Application Publication
(10) Pub. No.: US 2012/0133515 A1
(43) Pub. Date: May 31, 2012

(54) PAUSE ADVISER SYSTEM AND USE THEREOF

(75) Inventor: Troels Mikael Palshof, Gentofte (DK)

(73) Assignee: ASP TECHNOLOGY APS, København K (DK)

(21) Appl. No.: 13/380,112

(22) PCT Filed: Jun. 30, 2010
(86) PCT No.: PCT/DK10/50173

§ 371 Date: Feb. 13, 2012

(30) Foreign Application Priority Data
Jun. 30, 2009 (DK) PCT/DK2009/000163

(51) Int. Cl. G08B 23/00

(52) U.S. Cl. 340/575

(57) ABSTRACT

The invention relates to a pause advice device comprising: a pause algorithm being adapted to receive input from the input arrangement, said input arrangement being adapted to provide information to said pause algorithm to start-up the pause advice device, said pause algorithm being adapted to receive a personal user profile from the input arrangement, said pause algorithm being adapted to provide user stimuli via said display means and/or via said audio source, said pause algorithm being adapted to receive response input from a user based on a users response to said user stimuli provided via said display means and/or via said audio source, said pause algorithm being adapted to provide an alarm signal via said display means and/or via said audio source, said alarm signal signaling preferred time for said user for resting according to said pause algorithm.

### BACKGROUND

In the past, a plurality of sleep and sleepiness monitors has been developed, one of these is described in GB 2320972. Here, a sleepiness monitor for a vehicle drive is described, providing warning indication of driver sleepiness. The warning indication is based on sensor input from sensors monitoring the vehicle and input from the driver.

### SUMMARY

The invention relates a pause advice device, said pause advice device comprising:
a housing,
an input arrangement for receiving input from a user,
an audio source for providing an audio signal,
a display means for providing a visual signal,
an internal clock for keeping track of time,
a data processing unit,
a data storage circuitry for storing data,
a pause algorithm embedded in said data storage circuitry, and
power means for supplying power,

said pause algorithm being adapted to receive input from the input arrangement,

said input arrangement being adapted to receive input in the form of a personal user profile,

said input arrangement (IA) being adapted to provide information to said pause algorithm (PA) to start-up calculation of a fatigue level of said user,

said pause algorithm being adapted to receive said personal user profile from the input arrangement,

said pause algorithm being adapted to provide user stimuli via said display means and/or via said audio source,

said pause algorithm being adapted to receive response input from a user based on a user's response to said user stimuli provided via said display means and/or via said audio source,

said pause algorithm being adapted to provide an alarm signal via said display means and/or via said audio source, said alarm signal signaling preferred time for said user for resting according to said pause algorithm,

said alarm signal being provided at least on the basis of said response input and on said personal user profile.

The start-up information provided to the pause algorithm preferably originates from the input arrangement in form of a signal from a motion sensor and/or from a switch detecting when the pause advice device is mounted e.g. on a magnetic base part.

According to an embodiment of the invention, the calculation of the fatigue level of the user made by the pause algorithm begins when the pause advice device receives input that the pause advice device is mounted on a magnetic base plate and receives input that the pause advice device is moving

It should be noted that the data storage circuitry may comprise one or more separate data storage circuitries i.e. e.g. the pause algorithm may be stored in one data storage circuitry and e.g. data relating the personal user profile to the reference data may be stored in another data storage circuitry.

It should be noted that keeping track of time includes keeping track of the time of the day e.g. whether the time is 9:00 in the morning or 21:00 in the evening. Furthermore, keeping track of the time may e.g. include informing the pause algorithm when a time zone is passed, whether the current time is summer time or winter time, etc.

It is preferred that all elements of the pause advice device are comprised within or as part of a housing. The fact that the pause advice device is completely integrated within the housing of the pause advice device makes the pause advice device very easy to install e.g. in a car.

Furthermore, the pause advice device is ready to use as soon as it has been placed e.g. on the dashboard of a car since no integration with neither mechanical nor electrical parts of the car is necessary.

The fact that no integration with part of the car is necessary furthermore makes it very easy to use the pause advice device in more than one car. If e.g. the car needs service and the garage offers a courtesy car, it is easy to bring the pause advice device from the first car to the courtesy car and back when the service is completed.

Another example would be using the pause advice device while driving to work. Then it may be possible e.g. due to change of settings of the pause advice device to use the pause advice device at the working place and again use the pause advice device on the drive home from work. In this way the user may be advised of the preferred time of resting in different situations during the whole day.

The personal user profile describes the personal physiological conditions of the user such as age, gender, weight, information of the user's normal sleep pattern, information of use of medicine, etc. Hence the physiological condition is preferably related to physiological conditions related to fatigue level

Because of the personal user profile it is possible for more than one user to use the pause advice device. A new user only needs to provide his personal user profile and e.g. the current fatigue level and the pause advice device is ready to use for the new user.

It should be noted that throughout this document the term “alarm signal” may also sometimes be referred to as “pause advice”.

The alarm signal may e.g. be an audio signal from an audio source or a light signal from the display means or a combination of the two

The accuracy of the fatigue level calculated by the pause algorithm is increased when the current fatigue level is provided by the user and when the pause algorithm has at least one response time to use in the calculations.

Accuracy in relation to fatigue level is subjective, but according to the personal user profile and input from sensors and the user, it is possible to predict a preferred time of resting.

In an embodiment of the invention, said input arrangement being adapted to receive current fatigue level from said user.

In an embodiment of the invention, said pause algorithm being adapted to determine a fatigue level of a user based on said personal user profile.

The pause algorithm may determine the fatigue level of a user by calculations made based on input from the user, input from sensors for the pause advice device and reference data which is stored in the digital data storage circuitry.

In an embodiment of the invention, said pause algorithm being adapted to determine a fatigue level of a user additionally based on said current fatigue level and characteristics of said response input.

Characteristics of said response input is preferably the time from a user stimuli is provided until the use's response to the user stimuli is received by the pause advice device. Another characteristic of said response input may be the time from a user's response to a user stimuli and to a predefined or user specified period of time, etc.

In an embodiment of the invention, said input arrangement is divided into at least two input arrangements wherein a first input arrangement being adapted to receive a personal user profile and a second input arrangement being adapted to receive current fatigue level and response to user stimuli.

In an embodiment of the invention, a first input arrangement being adapted to receive said personal user profile and a second input arrangement being adapted to receive said current fatigue level and said response to user stimuli.

The second input arrangement may be a specific part of the top of the housing of the pause advice device in the contrary to the first input arrangement which may not be located at the top of the housing.

Further input arrangements may be locate as a part of the top of the housing of the pause advice device and may be used to receive response to user stimuli. It should be noted that the second input arrangement may also be used to receive response to user stimuli.

In an embodiment of the invention, said pause algorithm is configured for provide user stimuli and receive response input repeatedly at intervals wherein said intervals being determined on the basis of said fatigue level of the user.

The user stimuli may be provided according to the calculated or assessed fatigue level which is based on e.g. the personal user profile, reaction time, drive time, etc.

It is preferred that the pause algorithm provides user stimuli and receives response input repeatedly at predefined intervals when the personal advice device is in motion.

In an embodiment of the invention, said input arrangement comprises at least an input sensor chosen from the list consisting of:
audio sensor for sensing level of sound
light sensor for sensing level of light according to a predefined threshold
touch sensor for sensing when a user touches said pause advice device
motion sensor for sensing motion of the pause advice device

The motion sensor may by implemented as an accelerometer, a GPS (GPS; Global Position System) module, a vibration sensor, etc.

In an embodiment of the invention, said input arrangement for input of a personal user profile provides a range of predefined personal user profiles to be selected by said user.

The pause advice device being adapted to receive input from a user of the pause advice device, from a data communication link, in the form of data acquisition from the surroundings, etc. Due to the different nature of these input sources, the input arrangement is preferably divided into a plurality of different input arrangements, each being adapted for receiving a specific type of input information.

Input from the use may e.g. be received by means of a touch sensor located as part of the housing or beneath the housing, enabling the user to provide input to the pause advice device simply by touching the pause advice device.

Input from a data communication link may e.g. be received by means of a module capable of communicating via WLAN (WLAN: Wireless Local Area Network), Bluetooth or a cable connection based on e.g. LAN (LAN: Local Area Network) or USB (USB: Universal Serial Bus) technologies or the like.

Data acquisition may be obtained by sensors or measuring units such as a microphone, light level sensor, vibration sensor, etc.

Furthermore, the pause advice device may be equipped with switches or other mechanical or electrical arrangements adapting the pause advice device to receiving information. Such arrangement may e.g. be used to provide a personal user profile to the pause advice device.

In an embodiment of the invention, said response input is the user's response time from said user stimuli until said user activates said input arrangement as a response to said user stimuli.

The user's response time to user stimuli is an important input to the pause algorithm to determine the fatigue level of a user and thereby when to advice the user to rest.

In an embodiment of the invention, said pause advice device comprises a data storage circuitry comprising reference data used by the pause algorithm to interpret the personal user profile.

The data storage circuitry may be used to store information acquired during use of the pause advice device. Such information is very important to consider when calculating the fatigue level of a driver of a car. Acquired data could e.g. be response time to user stimuli, time since last rest, time of the day, etc.

Reference data is preferably stored in the data storage circuitry before the user purchase the pause advice data. The pause algorithm uses the reference data to interpret the personal user profile to be able to interpret the acquired data in the light of the personal user profile. Thereby is obtained the possibility for the pause algorithm to attach more importance to the acquired data such as the response time, drive timer etc. when the user has a first personal user profile compared to another user having a second user profile.

Reference data includes scientifically validated fatigue data. The reference data e.g. describes relationship between age, time of day, time of year, time since last sleep, etc. and the current fatigue level of the user and is used in combination with the personal user profile to personify the pause advice device to perform user-defined pause advices.

Hence reference data may be used by the pause advice algorithm to attach importance to fatigue factors i.e. how important one fatigue factor is compared to another fatigue factor. In other words the fatigue factors are interpreted in the light of the reference data.

It should be noted that the pause algorithm may also use reference data to interpret the fatigue level and input from sensors.

In an embodiment of the invention, said personal user profile is established by means of additional resources external to said pause advice device.

According to an advantageous embodiment of the invention, the additional resources may be a site on the internet, a page in the manual to the pause advice device, etc. The additional resource comprises questions the user needs to answer in order to derive the user's personal user profile categorizing the user. The questions relate to gender, age, sleep pattern, weekly hours of work, average hours of sleep at night, accidents, diseases, use of medicine, etc. and scores are given depending on the answers. Depending on the amount of scores, the personal user profile is determined.

Based on reference data related to the category in which the personal user profile places the user, the user's personal user profile uses the reference data to estimate the fatigue level and thereby the pause advice device becomes at least partly user specific.

In an embodiment of the invention, the user's current fatigue level is loaded into said pause advice device by means of said input arrangement.

The user's fatigue level is a measure of how tired the user of the pause advice device is i.e. the likelyhood of the user getting involved in fatigue related accident. If a user's fatigue level is high, this user needs to rest in contrary to a user having a low fatigue level, the latter user does not need to rest. The fatigue level of a user is determined or calculated based on three categories of information. The first category is the personal user profile of the user interpreted in the light of the reference data. The second category is the current fatigue level provided by the user. The third category is the actual status obtained by means of input data form sensors such input data may e.g. be time since the user last rested, age, gender, weight, quality of last night's sleep, etc.

The personal user profile together with input from the input arrangement e.g. sensor input and current fatigue level is used by the pause advice device to determine time between user stimuli and rests. If the user feels more tired than usual, the user is able to provide to the pause advice device the user's current fatigue level—an offset to the calculations of the next user stimuli or pause advice.

The current fatigue level may be established based on additional resources e.g. by answering questions from a questionnaire such as hours of sleep last night compared to a normal night, hours awake before this drive, use of medicine, intake of alcohol, etc. and marks are given depending on the answers. Depending on the amount of marks, the current fatigue level may be determined.

The current fatigue level may e.g. be loaded into the pause advice device by the touch sensor.

In an embodiment of the invention, said display means and/or said audio source being adapted to continuously communicate the current fatigue level of the user.

It is a very advantageous feature that the user is able to monitor his current fatigue level, also sometimes referred to as real time fatigue level. Hence, if the user is informed that he is soon advised to rest, it becomes possible for the user to plan his work or drive accordingly. He may e.g. park the car or truck and rest before entering a highway or he may rest before starting a new task at the office.

The audio source is preferably capable of emitting polyphonic tones. The audio source may be located as part of the housing or within the housing e.g. beneath a hole in the housing. The audio source may be a speaker or an audio source integrated with a printed circuit board within the housing.

In an embodiment of the invention, said alarm signal is an advice to said user of the preferred time for resting and wherein said preferred time for resting occurs when said fatigue level reaches a fatigue level threshold.

It is a very advantageous feature that the pause advice device advices the user when the fatigue level threshold is reached that now the optimal time for resting has occurred. The advice is preferably communicated by means of the output arrangement, e.g. by light or sound, and because the user is reminded, the user does not need to plan or remember when to rest.

This fatigue level threshold is dynamic in the sense that it is partly determined by the user's response time in the interaction with the pause advice device. The longer time from the user stimuli is communicated to the response from the user is registered, the more tired the pause advice device interprets the user to be. In this situation, the pause advice device e.g. increases the calculated fatigue level whereby the recommendation to take a break will occur earlier than the original estimate.

In an embodiment of the invention, said pause advice device being adapted to communicate to said user when said rest is over via said display means and/or via said audio source.

It is a very advantageous feature that the pause advice device informs the user when the rest is over. If the user is in a hurry, he knows that the rest is only as long as necessary for continuing with a safe and sound fatigue level.

In an embodiment of the invention, a warning signal is provided by said pause advice device if said user fails to respond to said user stimuli.

The warning may be the same light/sound combination as the user stimuli but the warning signal may increase in intensity and strength and may end up in a warning signal different from the user stimuli e.g. an alarm.

The user stimuli or the warning signal may be repeated e.g. with time intervals of 10 seconds to 10 minutes between the user stimuli or the warning signal until the motions sensor provide input to the pause algorithm/pause advice device that the vehicle has stopped.

The alarm may distinguish from user stimuli and alarm signals in loudness and e.g. in display pattern of light from the display means. Hence, by the loudness or display pattern, the user's attention is drawn to the fact that response to a user stimuli and/or warning signal is missing.

The period of time may e.g. be random or following an exponential curve form so that the period between the repeating user stimuli/warning signal may be 5, 4, 4, 3, 3, 2, 2, 2, . . . , 2 minutes e.g. with an increasing intensity in light and sound level.

In an embodiment of the invention, said input arrangement comprises a motion sensor for measuring movement of said pause advice device initiating said pause algorithm.

To optimize energy consumption of the pause advice device, a motion sensor may be integrated to measure whether e.g. a car in which the pause advice device is used is moving or not. This is one way for the pause advice device to determine whether the driver of the car is driving or resting which is relevant in relation to the processing of the pause algorithm. Hence, if the driver is driving, the next output from the pause algorithm/from the pause advice device might be a user stimuli or an advice to rest and if the driver is resting, the next output from the pause algorithm/from the pause advice might be a signal signaling that the preferred rest period is over.

The motion sensor may, furthermore, be used to power up the pause advice device or e.g. start up the pause advice device from standby mode.

In an embodiment of the invention, said housing comprises at least a first housing part and a second housing part.

Dividing the housing into a first and a second housing part is very advantageous because it then becomes possible to encapsulate some more fragile parts better than other non-fragile part. Fragile may e.g. be understood as sensitive to dust, vapour, etc.

Preferably, the first housing part encapsulates the electrical components such as the sensors, light and audio source, etc. Furthermore the first housing part may facilitate input e.g. via the input arrangement or power from the power source. Hence, when the second housing part is connected to the first housing part, the power source and the input arrangement also become encapsulated.

The connection of the first and second housing part is easy to use e.g. by turning of clicking. This is very advantageously because it enables easy access to the input arrangement if e.g. the personal user profile needs to be changed and easy access to the power supply if e.g. a battery needs to be changed.

In an embodiment of the invention, said pause advice device is removable mounted on a magnetic base part.

It may be advantageous if the second housing part is made at least partly of a magnetic material because then it is possible to mount the pause advice device on a magnetic surface. Such magnetic surface may e.g. be a magnetic base part which may be small in size and easy to mount e.g. on a table or a dashboard of a car e.g. by use of an adhesive material. Whether or not such magnetic base part is releasably mounted, it enables the easy mounting of the pause advice device on the magnetic base part.

A further advantage of mounting the pause advice device on a magnetic base part is that the magnetism of the base part could be used in the control of the pause advice device e.g. turn on or off the pause advice device or energize the pause advice device by means of induction principles. The latter would be very advantageous if the magnetic base part is integrated e.g. in the dashboard of a car.

In an embodiment of the invention, said magnetic base part when mounted on as surface being adapted to fasten said pause advice device to said surface.

When the magnetic base part is mounted on a surface such as the dashboard of at boat, plane or car, at a work station at an office, etc. The magnetic based part ensures that the pause advice device stays in a position on the surface determined by the magnetic base plate.

In an embodiment of the invention, said housing encapsulates said pause advice device and at least one further application.

It may be very advantageous to integrate further applications within the housing encapsulating the pause advice device or to integrate the pause advice device into the housing enclosing a further application. Examples of such further applications may be a handheld GPS, smartphone, dashboard of a car or existing applications of a car such as radio, GPS module, etc.

If a pause advice device and a handheld GPS or a GPS build into a car are comprised by the same housing, some of the components of the pause advice device and the GPS could be shared and the synergy of such integration would provide additional features to the user. Such additional features could e.g. be to provide map/road information to the pause algorithm, enabling the pause algorithm to take into account the different road categories. This is advantageous because e.g. large straight highways require more concentration than small winding roads and thereby a driver may need an additional rest after a certain time of driving on a highway compared to driving the same time on a small winding road.

In an embodiment of the invention, said data processor unit, said motion sensor, said display means, said audio source, said input arrangement, said internal clock and said power supply may be shared between said pause advice device and said further application.

It may be advantageous to be able to share components between the pause advice device and a further application to reduce costs in relation to manufacturing such multifunctional device. Components which may be obvious to share may e.g. be power supply, display (e.g. acting both as input arrangement and output arrangement), data processor, data storage, motion sensor such as a GPS module, etc.

In an embodiment of the invention an output/input arrangement facilitates download and/or upload of data between said pause advice device and an external device, such as a PC, a smart phone or the like.

The output/input arrangement may communicate by a data communication link based on e.g. WLAN (WLAN: Wireless Local Area Network), Bluetooth or a cable connection based on e.g. LAN (LAN: Local Area Network) or USB (USB: Universal Serial Bus) technologies or the like.

Download and/or upload of data may allow the user to review and store data from a drive, download of data may be useful in scientific study of accidents related to the fatigue level of the driver or download of data may be used to see if traffic rules are followed.

In an embodiment of the invention said pause advice device facilitates that said motion sensor provides acceleration information relating to situations of being accelerated or decelerated in a direction parallel to a forward direction of movement, and/or in a direction perpendicular to said forward direction of movement in the horizontal plane of movement and/or in a direction perpendicular to said forward direction of movement in the vertical plane of movement, or in any combination of such movements, thereby providing information relating to the degree of monotony of said movement of said pause advice device.

By the term “forward direction of movement” shall be understood the direction of driving in case the pause advice device is arranged in a car. Similar interpretations shall be applied in other situations.

This embodiment has the advantage that a further input can be supplied to said pause algorithm supplying characteristics relating to the degree of monotony of e.g. the nature or style of the user's driving in a car. It is well known a high degree of monotony of driving reduces a driver's alertness towards dangerous situations and increases the driver's fatigue level relative more than in a non-monotony situation.

Therefore it is advantageous to be able to adapt the pause algorithm to the degree of monotony of the style of driving which may e.g. be dictated by the topology of the roads.

In an embodiment of the invention said pause advice device pause algorithm being adapted to receive said input in the form of said acceleration information.

In an embodiment of the invention said pause algorithm being adapted to calculate said fatigue level on the basis of inter alia said acceleration information.

In an embodiment of the invention said pause algorithm being adapted to provide said alarm signal on the basis of this fatigue level.

These embodiments have the advantage that a further input can be supplied to said pause algorithm supplying characteristics relating to the degree of monotony of e.g.

the nature or style of the user's driving in a car. It is well known a high degree of monotony of driving reduces a driver's alertness towards dangerous situations and increases the driver's fatigue level relative more than in a non-monotony situation. Therefore it is advantageous to be able to adapt the pause algorithm to the degree of monotony of the style of driving which may e.g. be dictated by the topology of the roads. In a situation in which the driving is highly monotonous, the pause algorithm may according to these embodiments calculate a higher fatigue levels, compared to other driving situations, and as a consequence of this provide user stimuli and alarm signals at a higher frequency.

In an embodiment of the invention said pause algorithm being adapted to recognize that a vehicle comprising said pause advice device (PAD) is hitting rumble strips on the road, e.g. due to being positioned offset on a road, and wherein said pause algorithm (PA) being adapted to provide an alarm signal on the basis of said recognition.

As a supplement to the sound originating from the tires hitting the rumble strips, also an alarm signal will be provided to the user in this embodiment in order to make the user more alert. This will increase safety in driving.

In an embodiment of the invention said pause algorithm being adapted to delay, in a predetermined amount of time, the provision of a user stimuli and/or an alarm signal occasioned on the basis of information not relating to acceleration information in a situation in which the acceleration information that is being provided to the pause algorithm (PA) indicates that a predefined acceleration is encountered in direction parallel to a forward direction of movement, and/or in a direction perpendicular to said forward direction of movement in the horizontal plane of movement and/or in a direction perpendicular to said forward direction of movement in the vertical plane of movement, or in any combination of such movements, thereby indicating that a non-monotony movement of the pause advice device (PAD) taking place, and thereby avoiding interaction with the user in a difficult driving situation, to minimize any distracting elements from the Pause Advise Device

This embodiment has the advantage that during a dangerous situation involving acceleration or deceleration in one or more directions, the pause advice device will not provide user stimuli signals or alarms signals. Hence, the user can in such situation concentrate on the safe driving rather than having to respond to the user stimuli signals and/or alarm signals that would otherwise have been provided.

The delay may amount to a time span of 1-130 sec., such as 5-110 sec., e.g. 10-100 sec., such as 20-90 sec, for example 30-80 sec., such as 40-70 sec., e.g. 50-60 sec.

Moreover, the invention relates to a multifunctional device comprising a pause advice device as described in claims 1-30.

In an embodiment of the invention said multifunctional device comprises a personal computer.

A computer may include personal computers, laptops, notebooks, I-pads, PDA's, etc.

In an embodiment said multifunctional device comprises a positioning system such as a global position system.

In an embodiment said multifunctional device comprises a smartphone.

A smartphone should be understood as a portable device such as a mobile phone that offers more advanced computing ability and connectivity than basic mobile phones. An example of a smartphone may be an I-phone.

It should be mentioned that if the computing ability of a basic mobile phone is sufficient the multifunctional device may comprise a basic mobile phone.

Moreover, the invention relates to means of transportation such as a vehicle, vessel or a plane comprising a pause advise device as described in claims 1-30 or a multifunctional device according to any of the claims 31-34.

Moreover the invention relates to the use of a pause advise device as described in claims 1-30 or a multifunctional device according to any of the claims 31 - 34.

### FIGURE LIST

FIG. 1 illustrates an overview of the pause advisor system,

FIG. 2a illustrates a conceptual use of the pause advisor system,

FIG. 2b illustrates a result of a conceptual use of the pause advisor system,

FIG. 2c illustrates a rest pattern reflecting the result of the conceptual use of the pause advisor system,

FIG. 3 illustrates a specific use of the pause advisor system,

FIG. 4 illustrates interactions between the pause advisor system and additional recourses,

FIG. 5 illustrates an embodiment of the invention where the housing only encloses a pause advice device,

FIG. 6 illustrates an embodiment of the invention where the housing encloses a multifunctional device comprising a pause advice device, and

FIG. 7 illustrates a schematic view of the pause advice device according to a preferred embodiment of the invention.

### DESCRIPTION

Reference data RD is a representation of scientifically validated fatigue factors affecting the fatigue level FL of a person including a person driving a vehicle, statistics related to factors affecting the fatigue level FL of a person including a person driving a vehicle and results of user tests of prototypes of the pause advice device PAD.

From the scientifically validated fatigue factors, the statistics and the result of the user test fatigue factors are derived relating to different groups of persons. Fatigue factors may also sometimes be referred to as fatigue data. Hence, a fatigue factor influencing the fatigue level of a person above 70 years may not influence the fatigue level of a person of 25 years. In this way, fatigue factors influencing a group of persons are summarized and referred to as reference data RD for this specific group of persons.

The scientifically validated factors, the statistics and the result of the user tests has revealed that preferably users of the pause advice device PAD can be divided into eight groups where the fatigue level FL of persons of each of these different eight groups are influenced differently on the same fatigue factors. Hence for example persons of one group needs a higher frequency of user stimuli in the evening than persons of a second group. All of the fatigue factors may be referred to when referring to reference data RD.

The personal user profile PUP is a profile reflecting the physiological conditions of a person. The personal user profile PUP may be established by answering questions relating e.g. to age, weight, employment, etc. from a questionnaire or the like. Based on the answers, the person answering is categorized e.g. in one of the above mentioned eight groups.

From this definition of reference data RD and personal user profile PUP, it is obvious that the personal user profile is very important for the pause advice device PAD to be able to advice a user of the preferred time of resting. This is because when the pause algorithm PA is provided with a group reflected by the personal user profile PUP of a user, the pause algorithm PA uses the reference data RD related to that group in the estimations of the preferred time for resting.

Beside the information obtained based on the personal user profile PUP, the pause algorithm PA also uses sensor input data SID and user input data UID to estimate the fatigue level of the user and thereby the preferred time for the next rest.

As mentioned above, the groups of persons are made based on the effect of fatigue factors on persons within a group. Preferably, eight groups are defined, but the number of groups is not essential, hence, both more or less than eight groups may be defined.

Persons representing the first group have the lowest score when the personal user profile PUP is made, hence, such person may e.g. be a woman over 26 years who is taking no medicine, working day time, etc.

Persons representing group no. 8 are having the highest score when the personal user profile PUP is made, hence, such person may e.g. be a male of 20 years, working at night and has previously fallen asleep at the wheel.

The fatigue factors also referred to as fatigue data affecting the fatigue level FL of a person may be divided in at least three categories. The first category depends on the type of person e.g. age, gender, hours at work, hours of sleep. The second category depends on the current fatigue level CF e.g. working at night, intake of medicine or alcohol, hours since last sleep, amount of sleep last 2-3 days, ect. The third category depends on the present drive such as e.g. time since the last rest, total amount of driving time, time of the day/night, reaction time, etc.

The relationship between fatigue factors of the three categories and the risk of being exposed to a sleep-related accident is converted into preferred time between rests during a drive in each of the groups of persons. This conversion of fatigue factors into drive time between two rests is made based on scientifically validated data related to fatigue level of a person as described elsewhere in this document. Furthermore, reference data/fatigue data is used in the conversion to calibrate the time between two rests e.g. when the user provides his current fatigue level CF to the pause advice device PAD.

One of the most important user input data UID is the user's response to a stimuli from the pause advice device PAD. From such response the pause advice device PAD may calculate the user's response time to such stimuli. Another important user input data UID is adjustment of the current fatigue level CF used by the pause algorithm PA as an offset reflecting the current fatigue level CF of the user e.g. before a drive starts.

Furthermore, user input data UID may e.g. be adjustment of light or sound level on the pause advice device PAD, etc. If the pause advice device PAD comprises a microphone, user input data UID may be the user's voice or other sounds, etc.

The sensor input data SID originates from the input arrangement IA also sometimes referred to as sensor input arrangement SI and may e.g. be measured from the surroundings of the pause advice device PAD, data and time information, etc. Such measures could e.g. be level of light or noise, vibrations, temperature, time since last sleep, total driving time lasts 24 hours, etc.

When referring to a housing H, reference is preferably made to an enclosure encapsulating the individual elements of the pause advice device PAD. The housing

H may e.g. be made of metal such as aluminium or a polymer or a combination of metal and polymers/plastics.

The housing H may comprise a first housing part H1 and a second housing part H2. FIG. 7 illustrates such embodiment in a very schematic way. The first housing part H1 encapsulates the main components of the pause advice device PAD and the second housing part H2 may be releasable mounted to the first housing part H1 forming a cover e.g. for the input arrangement IA and power supply PS.

In case the second housing part H2 is a bottom part made of a magnetic metal, the pause advice device PAD may be releasable mounted to a magnetic base part MB. The magnetic base part MB may be fastened e.g. to a dashboard of a car with an adhesive material or fastening means such as screws. Such releasable mounting facilitates quick release of the pause advice device PAD e.g. from the dashboard for a car. Furthermore, the magnetic connection may also be used as s switch for turning the pause advice device PAD on and off.

It should be mentioned that the housing H may enclose other devices than the pause advice device PAD.

When referring to input arrangement IA, reference is preferably made to one or more mechanical switches through which the user of the pause advice device PAD is able to adjust the pause advice device PAD. Such adjustment could e.g. be an initial base line adjustment where the pause advice device PAD is adjusted according to the personal user profile PUP of the user of the pause advice device PAD.

It should be noted that input arrangement IA may also refer to a data communication interface through which data such as personal user profile PUP, general or user-defined settings, etc. may be provided to the data advice device PAD. The data communication interface may e.g. use LAN (LAN; Local Area Network), WLAN (WLAN; Wireless Local Area Network), Bluetooth or the like.

Sometimes a reference to input arrangement IA may also refer to the touch sensor and motion sensor which is described below.

When referring to motion sensor MS, reference is preferably made to a vibration sensor e.g. in the form of an accelerometer. The motion sensor supplies the data processor DP and/or the pause algorithm PA with information about when the pause advice device PAD is in use e.g. by measuring vibrations originating from a running or driving car.

An alternative to the vibration sensor could be a GPS (GPS; Global Position System) module integrated in the pause advice device PAD which based on determining the position of a car determines if the car is running or driving.

It should be noted that if the pause advice device PAD is build into a further device or share the same housing H with a further device such as a handheld GPS, smartphone, PDA (PDA; Personal Data Assistant), etc. having a GPS module, the GPS module of such device may be used as a motion sensor.

When referring to audio source AS, reference is preferably made to a polyphonic audio source. The polyphonic audio source provides user stimuli, alarms or other information from the pause advice device PAD to the surroundings e.g. in the form of predetermined sequences of tones, commands (voice), etc.

It should be mentioned that audio sources only capable of providing simple beeps may also be used as well as speakers for improving the quality of the user stimuli, alarms, etc.

When referring to display means DM, reference is preferably made to light emitting diodes. The light emitting diodes may be of different colors depending on what to communicate to the user of the pause advice device PAD. Furthermore, e.g. eight light emitting diodes may be placed next to each other forming scale. Such scale may e.g. be used to communicate the current fatigue level to the user, used by the user to provide the current fatigue level of the user to the pause advice device PAD, etc.

In situations where the light emitting diodes form a scale, the light emitting diodes may form part of the housing H. Alternatively, the light emitting diodes are placed beneath a transparent part of the housing H.

It should be noted that the display means DM may also be implemented with few, e.g. only 1-3, light emitting diodes or as a matrix or segment display.

The touch sensor may be used by the user to respond to user stimuli or to adjust the current fatigue level, level of sound and light, etc.

When referring to an internal clock IC, reference is preferably made to a timer arrangement capable of providing information of time of the day, time of the year and capable of measuring the time between to events e.g. between a user stimuli and the response hereto.

When referring to a data processing unit DP, reference is preferably made to a microprocessor or other logical control units capable of executing instructions such as instructions referred to as pause algorithm. Furthermore, the data processing unit DP may control elements of the input arrangement IA, the data storage circuitry DSC, etc.

The pause algorithm, also sometimes referred to simply as algorithm, correlates information from the input arrangement IA, such as personal user profile PUP and current fatigue level, the touch sensor TS and the internal clock IC. The result of the correlation performed by the pause algorithm is e.g. current fatigue level, user stimuli, alarms etc. which are communicated to the user of the pause advice device PAD by the audio source and/or the display means.

When referring to a power supply, reference is preferably made to a battery capable of energizing the relevant parts of the pause advice device PAD. The relevant parts may e.g. be the data processor unit DP, audio source AS, display means LS, motion sensor MS, internal clock IC, etc.

Alternatively, the power supply PS may e.g. be a solar cell, a plug/socket connection to an external energy source or energy transfer by means of electromagnetic induction.

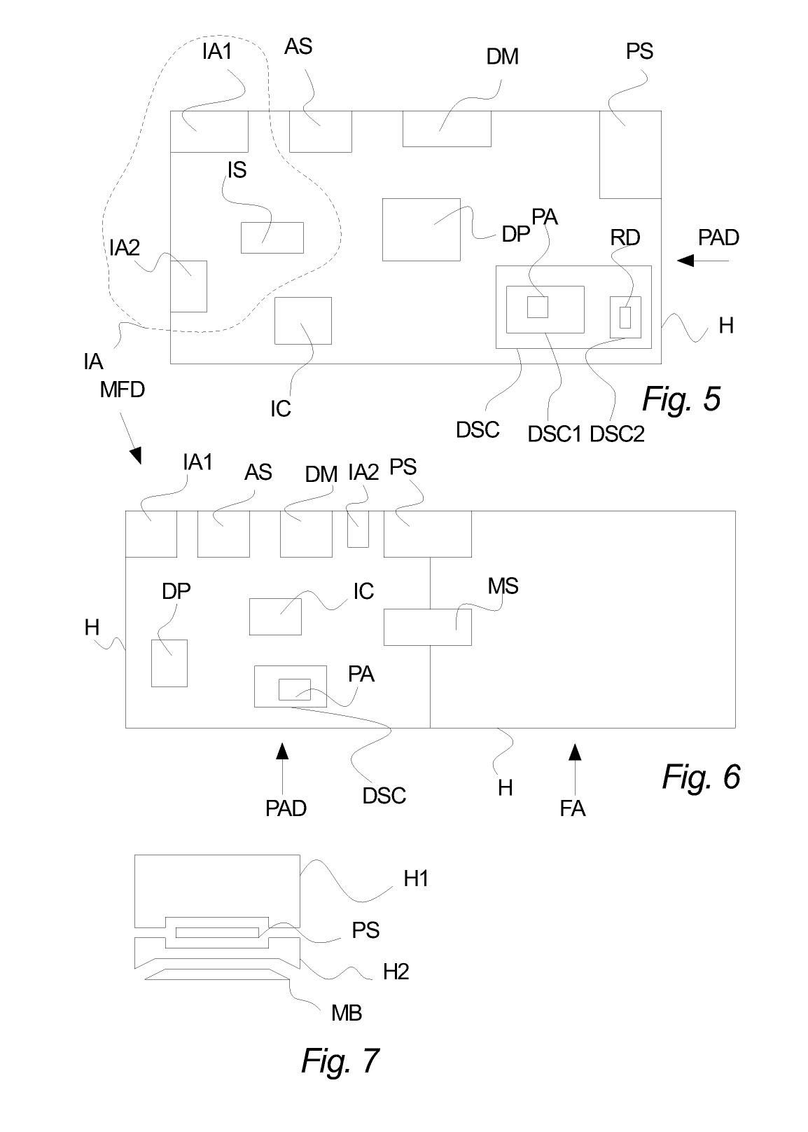

FIG. 5 is a schematic view of the pause advice device PAD, according to a preferred embodiment of the invention. FIG. 5 illustrates the housing H encapsulating the input arrangement IA, e.g. touch sensor IA1, motion sensor IA2, etc., audio source AS, display means DM, power supply PS, internal clock IC, data processing unit DP and data storage circuitry DSC comprising a first data storage circuitry DSC1 storing the pause algorithm PA and a second data storage circuitry DSC2 storing reference data RD.

On FIG. 5, the two input arrangements IA1 and IA2, audio source AS and display means DM e.g. a light source and power supply PS are illustrated as forming part of the housing H.

In situations where the input arrangement IA is forming part of the housing H, this part of the housing H may be a plug/socket data interface, a switch, a touch sensitive display, etc. In case the data communication interface is wireless, the input arrangement may not form part of the housing H.

In situations where the audio source AS is forming part of the housing H, this part of the housing H may be a hole facilitating audio waves escaping from the interior of the housing H.

In situations where the display means DM is forming part of the housing H, this part of the housing H may e.g. be one or more light emitting diodes. Alternatively, the display means DM may be located in the interior of the housing H and the part of the housing H may then be transparent enabling light escaping from the interior of the housing H.

In situations where the power supply PS is forming part of the housing H, this part of the housing H may be a socket facilitating connection of a plug, a battery, etc.

In situations where the touch sensor TS is forming part of the housing H, this part of the housing may be a button or a pressure sensitive material which when touched activates a switch or the like beneath the pressure sensitive material. Alternatively, the dimension of the area of the housing H intended for use as touch sensor may be decreased to optimize the sensitivity of e.g. a capacitive sensor beneath such area of the housing H.

FIG. 6 illustrates the pause advice device PAD, according to an embodiment of the invention, where the housing encapsulates the pause advice device PAD and one or more further applications FA. According to this embodiment of the invention, the housing H can be said to enclose a multifunctional device such as a Smartphone, PDA such as a handheld GPS, etc.

The multifunctional device illustrated in FIG. 6 comprises a pause advice device

PAD as illustrated in FIG. 6. The pause advice device PAD and the one or more further applications FA may share some hardware elements. In FIG. 6, only the motion sensor MS and the power supply PS is illustrated as shared between the pause advice device PDA and the further application FA. But also the data processor unit DP, the power supply PS, display means DM, audio source AS, etc. may be shared.

If e.g. a Smartphone comprises a display, this display could replace e.g. the light source, and if the display was a touch sensitive display, such display could replace the touch sensor in the pause advice device PAD. In the same way, other relevant hardware elements might be shared e.g. to lower the total costs in relation to hardware elements.

Furthermore, it should be noted that the pause advice device may be integrated in a car. Integrated should here be understood both as an integrated stand alone device and integrated in the sense that the car provides electrical or mechanical signals to the pause advice device.

Integrated as a stand alone device is preferably understood as taking the pause advice device PAD as described through this document and installing it behind a dashboard of a car not interacting with elements or components of the car. With this said, if the dashboard/car e.g. comprises a screen or speakers, it might be advantageously to make use of such screen or speakers, but it would not be necessary.

If the pause advice device is integrated into e.g. a vehicle, some of the electric signals of the car could be used as input to the pause algorithm PA. Such electric signals could e.g. be measures of fuel level to combine resting advice with filling up the car, or measures of steering wheel pressure by the driver, information of where on the road the vehicle is driving, etc.

If the vehicle comprises a GPS and road chart information or if the pause advice device PAD is build into a multifunctional device which comprises a GPS and road chart information, this information may be used by the pause algorithm PA. Based on input from GPS signals and road chart information, the pause advice device PAD may be able to schedule the recommended rest according to the specific drive i.e. e.g. advice rest at a gas station, picnic-area, etc. Furthermore, the combination of GPS signals and road chart information as input to the pause algorithm PA may be advantages. This is because the fatigue level of a driver often is increasingly affected by monotonously driving such as continuously driving e.g. on a highway which may then be accounted for in the calculation of the preferred time for resting adviced by the pause advice device PAD.

In relation to both FIGS. 5 and 6, it should be noted that the pause algorithm PA may be stored in a data storage circuitry DSC which may also store reference data RD and data acquired during use of the pause advice device PAD/multifunctional device MFD.

According to an embodiment of the invention the pause advice device PAD provides a start-up signal when the placed on the magnetic base MB. This start-up signal e.g. an light and/or audio signal informs the user that the pause advice device PAD is active and serves as a reminder to the user that a current fatigue level CF should be provided to the pause advice device PAD. If no movement is registered by the pause advise device PAD for a period of time e.g. 3 minutes the pause advice device PAD enters a standby mode for saving energy. When movement is registered the pause advise device PAD begins to acquire data and calculate the fatigue level of the user.

The pause advice device PAD may be part of a pause adviser system PAS.

The invention relates to a method for advising a user of a pause adviser system of a preferred time for resting, said pause adviser system comprising:
output arrangement enabling said pause adviser system) to communicate output advise data to said user,
user input arrangement enabling said user to provide user input data to said pause adviser system,
sensor input arrangement providing sensor input data to said pause adviser system,
data storage circuitry for storing reference data,

said method comprising the steps of:
establishing a personal user profile, representing the initial physiological conditions of said user,
loading said personal user profile into said pause adviser system,
by means of said pause adviser system establishing user stimuli on said output arrangement,
by means of said pause adviser system establishing a fatigue level on the basis of:
   said reference data,
   said personal user profile,
   user input data obtained by said user input arrangement in response to said user stimuli, and
   sensor input data obtained from said sensor input arrangement,

by means of a data processor, transforming said fatigue level into output advice data and communicating said output advice data to said output arrangement.

The present invention is a very advantageous pause adviser system that informs the user about his/her fatigue level and in due time recommends the user to rest before he/she becomes critically fatigued. The pause adviser system is especially advantageous when used in relation to monotonous or complex tasks such as driving, surveillance, machine operation, reading, writing, etc. Such tasks demand perception, good judgment, adequate response time, reasonable physical capability, focus and concentration, etc. The pause adviser system advices the user to rest according to a user specific rest pattern and thereby over time the user is able to remain focused on the task. When initiated, the pause adviser system only requires a minimum of attention from the user and performs four important functions: a) in real time measures the user's fatigue level, b) continuously interacts with the user by running non-intrusive alertness maintaining tasks that keeps the user focused, c) recommends the user to take a break when the user approaches a critical fatigue level and d) calculates the length of the break required for the user to recuperate. If the user remembers to rest frequently e.g. during a drive from Denmark to Italy the risk of the driver falling asleep is minimized. Not only is the risk minimized, the driver is also more fit for the complete drive if the driver rests appropriately during the trip, instead of driving 800 kilometers before resting for the first time.

The optimal distribution of pauses or rests in between work or drive sessions e.g. during an 8 hour working day, is when the rests are distributed so that the user is able to work or drive with full attention throughout the session, then rest only as much as necessary to be able to work or drive with full attention during the next session.

The present invention is advantageous because it is capable of estimating the optimal time for the next rest and the duration of this rest, for the user to be as fit as possible to continue e.g. to work or drive. This is according to an advantageous embodiment of the invention done by correlating reference data with results of response tests of the user, contextual sensor measurement and with a personal user profile.

Reference data is a representation of scientifically validated fatigue data, user input data and sensor input data. Scientifically validated fatigue data may be represented by reference data e.g. by look-up tables, encapsulated algorithms, etc.

According to an advantageous embodiment of the invention scientifically valid data describes factors and periods of time affecting the fatigue level of a person. Hence, when the user of the pause adviser system loads his personal user profile, describing initial personal physiological conditions of the user, into the pause adviser system, the pause adviser system match the personal user profile with the reference data. Based on this match the pause adviser system knows with which frequency this specific user needs to rest. On top of this information the pause adviser system tests the response time of the user to stimuli communicated from the pause adviser system. This response time is a parameter in the calculation of current or real time fatigue level of the user; hence, in combination with the reference data and personal user profile the optimal time for the user to rest is estimated.

According to an advantageous embodiment of the invention, output advice data is advantageously communicated to the user via light and/or sound, because a combination of light and sound can be registered by the user no matter if it is night or day, or whether the environment is noisy or not.

The output advice data may include user stimuli, which may be used, by the pause adviser system, to attract the user's attention e.g. to obtain a response time of a user upon user stimuli. Furthermore, the output data may include advices or alarms to the user to which the user needs to respond, the result of this interaction between the user and the pause adviser system is used in the estimation of the fatigue level of the user.

According to an advantageous embodiment of the invention, one category of user input data is advantageously obtained from a touch panel or by means of voice recognition and may be the response from the user upon user stimuli. A further category of user input data may also be obtained e.g. from the touch panel or mechanical switches. Information of this further category of user input data may be an offset adjustment of the user's fatigue level, adjustment of intensity of light or sound from the output arrangement if the user feels more fatigue than usual, etc.

According to an advantageous embodiment of the invention, sensor input data is data obtained from sensors such as light sensor, microphone, vibration sensor, touch panel, clock or timer, etc.

The light sensor obtains information or sensor input data on the ambient light conditions in the presence of the pause advisor system. This data may be used as reference for adjusting the intensity of light stimuli to the user. Furthermore, this data may be used as input to the estimation of the user's fatigue level.

The microphone obtains information or sensor input data of e.g. the background noise, used to adjust the intensity of the sound stimuli to the user. Furthermore, the microphone may be used to obtain user input data e.g. in form of voice response. It should be noted that one transducer may be used both as microphone and as speaker.

The vibration sensor obtains information or sensor input data of motion, if the pause advisor system e.g. is used in a car. This data is e.g. used to determine whether the engine of the car is stopped which indicates that the user is resting or a drive has ended. In the latter case this information may be used to activate standby mode or turn off the pause adviser system.

The touch panel is, as described above, used to obtain user input data such as e.g. a real time or current fatigue level adjustment, if the user e.g. feels more rested or more tired than usual or compared to what his/her personal user profile predicts.

The clock or timer is used to provide information of time into the estimations performed by the pause adviser system. The time domain is very advantageous because it enables the pause adviser system to calculate the duration of a drive or rest, provide information of time of the day and month of the year, etc.

According to an advantageous embodiment of the invention, the data storage circuitry may store reference data, sounds or light sequences, settings from previous use of the pause adviser system, etc. Furthermore, the data storage circuitry enables the pause adviser system to continuously store obtained sensor input data and user input data.

According to an advantageous embodiment of the invention, it may only be necessary to make the personal user profile once in the life time of the pause adviser system and this may preferably be before the user uses the pause adviser system for the first time. If the user's physiological conditions should change e.g. over years it is necessary and possible to perform a new personal user profile test and load the result of this test to the pause adviser system.

It should be noted that it is possible to load a plurality of personal user profiles to the pause adviser system; hence, a plurality of users may use the pause adviser system. Furthermore, it should be noted that it may be possible to erase or edit a personal user profile provided to the pause adviser system. This could be necessary e.g. if the physiological conditions of the user changes or that the user experiences that his/her capabilities to handle fatigue are either worsened or getting better.

Furthermore, it should be noted that the pause advisor system may be able to estimate the fatigue level of a user who has not loaded a personal user profile to the pause adviser system, but in this situation the estimated fatigue level may not be user specific.

According to an advantageous embodiment of the invention said pause advisor system may communicate with sensor or power units via wired or wireless communication.

In an embodiment of the invention, said personal user profile is established by means of additional resources.

According to an advantageous embodiment of the invention, the additional resources may be a site on the internet, a page in the manual to the pause adviser system, etc. The additional recourse comprises questions the user needs to answer, in order to derive the users personal user profile the user is categorized. Based on reference data related to the category of user with this personal user profile the fatigue level estimation and thereby the pause adviser system becomes at least partly user specific.

In an embodiment of the invention, said personal user profile is loaded into said pause adviser system by means of said user input arrangement.

According to an advantageous embodiment of the invention, the user input arrangement comprises mechanical, electric or wireless arrangements used to load the personal user profile into said pause adviser system.

When the personal user profile is obtained it has to be loaded to the pause adviser. This may be done e.g. by a mechanical switch which may be adjusted according to the personal user profile e.g. between 1-10 different steps representing 1-10 predefined personal user profiles. Alternatively, it may be possible to adjust the personal user profile by means of an electric switch, contact or other electronic equipment e.g. also by touching. Alternatively, it may be possible to load de personal user profile by means of wireless communication arrangements such as Bluetooth, infrared, wi-fi, etc.

The latter two possibilities enables an increased number of different personal user profiles, because the number of possible physical steps in a mechanical switch is less than the number of steps that e.g. can be software implemented.

In an embodiment of the invention, a current fatigue level of a user of said pause adviser system is loaded into said pause adviser system by means of said user input arrangement.

During use of the pause advisor system, under normal conditions, the user's physiological conditions, as described by the personal user profile, is together with interactions with the pause advisor system basis for calculating the fatigue level for the user. If the user for some reason deviates from the normal conditions e.g. feels more tired due to stress or a minimum of sleep, the user may perform an adjustment of the current fatigue level. The current fatigue level adjustment adds an offset to the baseline adjustment or affects the fatigue level estimation to take into account that the user has informed the pause adviser system of the fact that the user is more tired than usual. Likewise the user may adjust current fatigue level to inform the pause adviser system that the user is less fatigued.

In an embodiment of the invention, said pause adviser system comprises a timer arrangement, said timer arrangement providing time data.

According to an advantageous embodiment of the invention, the timer arrangement is a repetitive clock, watch, etc. from which it is possible to derive time data representing the time of the day, month of the year, duration of a drive or work session, etc. This time data is according to an embodiment of the invention an essential part of the fatigue level estimation.

In an embodiment of the invention, said time data provided by said timer arrangement is used by said pause adviser system to establish said fatigue level.

The fatigue level of a user of the pause adviser system is affected by the time of the day of use of the pause adviser system. Humans are by nature diurnal (day orientated) as opposed to nocturnal (night orientated) beings, meaning that our physiological functions are geared towards day time activity and night time rest. This is also sometimes referred to as circadian rhythms. The human circadian rhythms are synchronized to one another by the internal biological clock, and entrained (daily reset) to the 24 hour day/night cycle by external time cues, namely the variation in sunlight and the increase in environmental and family activity around us. Hence, when it is dark the user tends to be more tired e.g. when driving, than when it is light outside. Furthermore, the fatigue level of a user is affected by the season of the year, hence, e.g. in Canada and Northern Europe during fall and winter it becomes dark in the afternoon and thereby the user is in a greater risk of getting tired in the afternoon in winter than in the afternoon in the summer.

Furthermore, it is possible to measure the time to the next rest, the duration of a rest, time since the last rest, etc.

Response time is closely related to the fatigue level of a person, when a person gets tired the person's response time increases. Therefore, it is advantageous to be able to measure the time from a stimuli is communicated from the output arrangement to the user responds to the stimuli via the user input arrangement. This time indicates if the person is tired or unfocused and even sometimes how tired the person is.

In an embodiment of the invention, said sensor input data represents the environment in which said pause adviser system is used.

The sensors of the pause adviser system are collecting data describing the environment or context in which the pause adviser system is used. In this way the pause adviser system is provided with information of e.g. ambient light intensity, in the ambience of the user or the pause adviser system which, as described, influences the fatigue level.

The sensors may also provide sensor input data comprising information of whether or not the car is moving or if the engine is turned off e.g. indicating whether the user is resting or driving.

In an embodiment of the invention, at least part of said sensor input data is provided by a vibration sensor.

Information of whether movement/motion is detected is very advantageous, especially if the pause adviser system is used in a car or truck, because vibration indicates whether or not the engine is started. This information may be used by the pause adviser system to register e.g. if the user is resting, the duration of a drive, to control power save functions of the pause adviser system, etc.

A vibration or movement sensor may according to an embodiment of the invention e.g. be a GPS (GPS; Global Positions System), accelerometer, piezo or capacitive acceleration sensor, omnidirectional micro vibration sensors or other mechanical or electrical devices adapted to sense vibrations, etc.

In an embodiment of the invention, said sensor input data provided by said vibration sensor is used as start and stop commands in the establishment of said fatigue level of said user.

According to an advanced embodiment of the invention, the vibration or motion sensor supplies data to the pause adviser system comprising information of whether the pause adviser system is exposed to vibrations or motion. This is advantageous because motion e.g. indicates that the user is driving which is used in the estimation or establishment of the fatigue level of the user. In the same way when the vibration or motion sensor does not supply vibration data to the pause adviser system, it indicates that the user is resting which is taken into account when the pause adviser system estimates or establishes the fatigue level of the user.

In other words, the input from the vibration sensor arrangement may according to an embodiment of the invention be applied to estimate whether the method results in the desired result, namely the user takes a break at the suggested time and/or that the length of the break is sufficient. Evidently, by incorporating these input data indicating whether and when a user is driving, it is possible to adjust the output advice accordingly.

In an embodiment of the invention, said output arrangement of said pause adviser system continuously communicates the real time fatigue level of the user.

It is a very advantageous feature that the user is able to monitor his current or real time fatigue level. Hence, if the user is informed that he will soon be advised to take a break, it becomes possible for the user to plan his work or drive accordingly. He may e.g. park the car or truck and rest before entering a highway or he may rest before starting a new task at the office. Preferably the user can monitor the fatigue level by means of light emitted from the output arrangement and be informed by light and sound when the recommended break or rest time is over.

In an embodiment of the invention, said output arrangement of said pause adviser system advises said user to rest,
said rest starting at said preferred time for resting, and
said preferred time for resting occurs when said fatigue level reaches a fatigue level threshold.

It is a very advantageous feature that the pause adviser system advices the user when the fatigue level threshold is reached that now the optimal time for resting has occurred. The advice is preferably communicated by means of the output arrangement, e.g. by light or sound, and because of he is reminded, the user does not need to plan or remember when to rest.

This fatigue level threshold is dynamic in the sense that it is partly determined by the user's response time in the interaction with the pause adviser system. The longer time from the user stimuli is communicated, to the response from the user is registered, the more tired the pause adviser system interprets the user to be. In this situation the pause adviser system e.g. lowers the fatigue level threshold whereby the recommendation to take a break will occur earlier than the original estimate.

In an embodiment of the invention, said pause adviser system communicates to said user when said rest is over.

It is a very advantageous feature that the pause adviser system informs the user when the rest is over. If the user is in a hurry he knows that the rest is only as long as necessary for continuing with a safe and sound fatigue level.

In an embodiment of the invention, an alarm is activated if said user fails to respond, via said user input arrangement, to said advice to rest.

When the fatigue level of the user is known, it is compared to a fatigue level threshold and if the fatigue level reaches or exceeds the fatigue level threshold the user is advised or recommended to rest. By interacting with the pause adviser system, the user needs to respond to the advice, to let the pause adviser system know that the advice is received by the user.

If the user does not respond to the advice to rest, within a time of e.g. 10 or 15 seconds, the advice is converted to an alarm, preferably be turning up the volume of the sound advising the user to rest, to a loud sound to get the users attention even if the user has fallen asleep.

When the alarm is activated the pause adviser system may be interpreted as an anti sleep system because the alarm will wake up the user if the user falls asleep and does not respond to user stimuli from the pause adviser system.

In an embodiment of the invention, said user overrules said alarm for a period of time by means of said user input arrangement.

It is very advantageous to be able to overrule or snooze the alarm or rest advise e.g. in the case where the pause adviser system is used in a car and the car is driving on a high way, with no exits near by. In this situation the alarm may be snoozed or postponed for a period of time of e.g. 1 to 10 minutes until the user gets the opportunity to stop the car and rest. The period of time may e.g. be random or following an exponential curve form so that the period the alarm or advice can be snoozed may be 5, 4, 4, 3, 3, 2, 2, 2, . . . , 2 minutes.

Another example where it might be very advantageous to be able to snooze the alarm is when the alarm is activated very close to the destination of e.g. a trip or at the end of a night shift at work. In this situation it may not give any sense to rest and the snooze opportunity is valuable.

In an embodiment of the invention, said pause adviser system comprising:
output arrangement in form of at least one illuminator and at least one speaker through which said pause adviser system communicates output advise data to said user,
user input arrangement in form of at least one touch panel through which said pause adviser system retrieves information from the user,
sensor input arrangement in form of at least one light sensor and at least one vibration sensor through which said pause adviser system retrieves information of the environment in which said pause adviser system is used, and
data storage circuitry for storing reference data and enabling said pause adviser system to continuously store said user input data and said sensor input data, said method comprising the steps of:
establishing a personal user profile, representing the initial physiological conditions of said user,
loading said personal user profile into said pause adviser system,
by means of said illuminator and said speaker said pause adviser system establishing user stimuli,
by means of said touch panel said pause adviser system retrieving the user's response time on said user stimuli,
by means of said light sensor and said vibrations sensor retrieving drive specific data, comprising information of a current drive,
by means of said personal user profile said response time and said drive specific data said pause adviser system establishing said fatigue level of said user, and
by means of a data processor, transforming said fatigue level into output advice data and communicating said output advice data to said illuminator and/or said speaker.

In an embodiment of the invention, said pause adviser system is implemented in a portable stand alone device.

The mobile implementation of the pause adviser system in a pause adviser device enables the user to use the pause adviser system in different locations such as in a car, truck, boot, office, etc.

Furthermore, the invention relates to a pause advisor system comprising a data processor implementing the method of claims 1-36.

In an advantageous embodiment of the invention, said pause adviser system is a device.

According to an advantageous embodiment of the invention, the pause adviser system device is portable which enables the user to use the pause adviser system in different locations such as in a car, truck, boot, office, etc.

Furthermore it is possible to mount the pause adviser system device by means of screws, glue, adhesive materials, hook and loop systems, etc.

The term “fatigue level” FL is used as a measure of how fit a user of the pause adviser system PAS is based on e.g. the user's U physiological conditions, how rested the user U feels, how long time the user U has been e.g. working or driving, etc.

The term “optimal time” is used to described the point in time where the user U of the pause adviser system PAS is advised to rest. The optimal time is estimated as described throughout this document i.e. in relation to driving; the optimal time is the point in time where the fatigue level FL indicates that the user U needs a rest to be able to continue the drive or work as focused as possible.

The term “rest” R is used to describe a pause or break. If a user U is at work the lunch break, a power nap, a walk, etc is considered as a rest. If a user U is driving a rest is considered as a stop where the user U e.g. stops the car, leaves the car, takes a nap, etc.

The term “estimation” is used to describe the “processing of data” which is necessary to obtain the fatigue level FL of the user U of the pause adviser system PAS. The estimation may preferably be performed by processing e.g. the following three categories of data.

The first category is data which scientifically has been identified to affect the fatigue level FL of a person. Preferably a representation of this data, e.g. the reference data RD, is stored in the pause adviser system PAS before the user U uses the pause adviser system PAS for the first time, e.g. before the user U buys the pause adviser system PAS.

The second data category is data loaded to the pause adviser system PAS before the user U takes the pause adviser system PAS in use for the first time, this data is also referred to as personal user profile PUP and is preferably loaded to the pause adviser system PAS by the user U.

The third data category is data obtained or recorded by the pause adviser system PAS during use as described below.

The term “stimuli” or user stimuli US is used to describe the alertness maintaining tasks carried out by interactions between the user U and the pause adviser system PAS. Hence, the user stimuli US is the part of the alertness maintaining interaction originating from the pause adviser system PAS to which the user U needs to respond. This correlation or processing of data may be controlled by an algorithm and this algorithm may, in various ways, be executed by one or more data processors DP. One example may be that the above-mentioned data, is stored in a data stored circuitry DSC such as a database or mechanically stored, e.g. by means of a switch, and from one of these storages the data processor DP accesses the information needed to estimate the fatigue level FL of the user U.

A second example may be that the above-mentioned data is encapsulated in an algorithm so that the algorithm in itself contains at least part of the data / information which is needed to estimate the fatigue level FL of the user U.

A third example may be that the above-mentioned data is replicated by an estimating algorithm; hence, the above mentioned data then constitutes the algorithm.

Data processor DB is understood as an electronic device—a data processing unit capable of processing data such as an integrated circuit, microcontrollers, micro processors, etc.

It should be noted that if nothing else is stated, the user U throughout this document is understood as the user U of the pause adviser system PAS and could be a person of both genders.

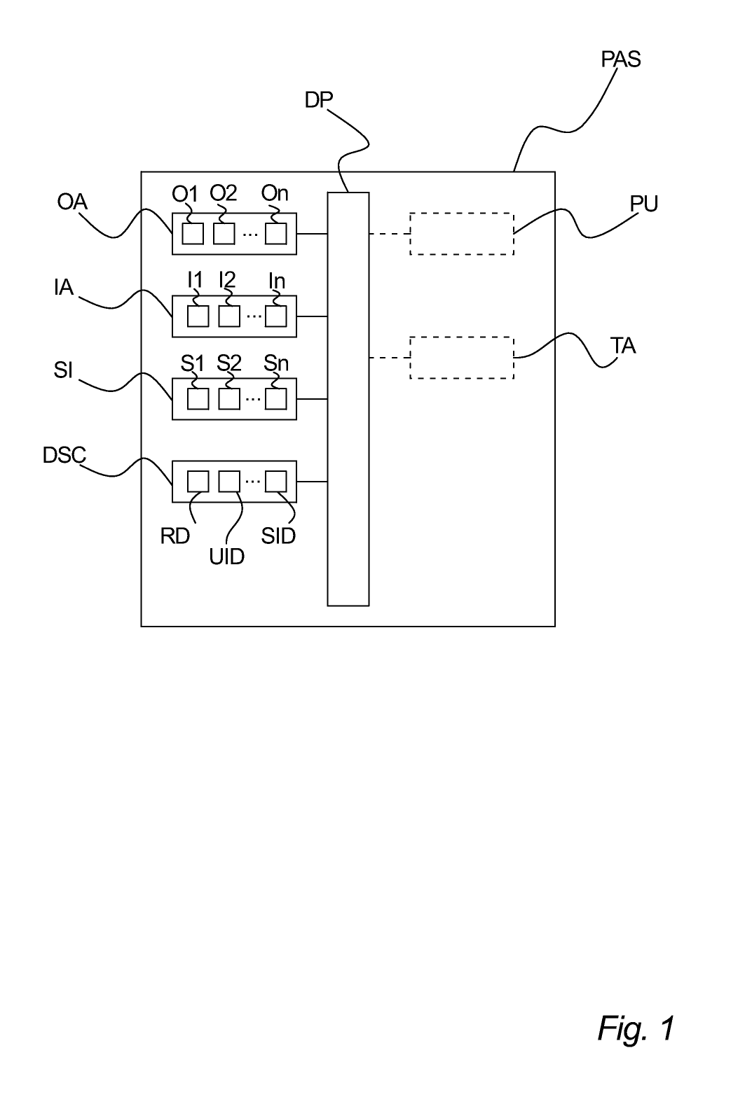

FIG. 1 illustrates the principles of a pause adviser system PAS according to an embodiment of the invention. The pause adviser system PAS comprises at least one user output arrangement OA, at least one user input arrangement IA, at least one sensor input arrangement SI at least one data processor DP and at least one data storage circuitry DSC.

Furthermore, the pause adviser system PAS may comprise at least one power unit PU and at least one timer arrangement TA.

The pause adviser system PAS may according to an embodiment of the invention be implemented in a stand alone device or as a part of or as a sub-element e.g. in a car, desktop or where ever users U need to be advised to rest. When the pause adviser system PAS is implemented in a portable stand alone device the pause adviser system PAS becomes mobile in the sense that it is movable and thereby the use of the pause adviser system PAS is not limited to only one physical location. Preferably a stand alone pause adviser system PAS may be used in a car while driving, at a desktop while working, at the office during night watch, etc.

The intention of using the pause adviser system PAS is to inform the user U of the current or real time fatigue level of the user U by means of the output arrangement

OA. When the fatigue level FL passes a fatigue level threshold FLT, the user U is informed that it is now the optimal time to rest and the output arrangement OA recommends the user to take a break. Preferably the output arrangement OA also informs the user U of the optimal length of this break.

The output arrangement OA enables the pause adviser system PAS to communicate output advise data OAD to the user U. The output advice data OAD may inform the user U of the user's U current fatigue level FL in real time or at least with predefined or random time intervals. By real time is understood as fast as the pause adviser system PAS is able to provide output advise data OAD. Furthermore, the output advise data OAD may be used for informing the user U that the pause adviser system PAS soon will require the user's U attention. If e.g. the pause adviser system PAS is going to use a loud sound to inform the user U that interaction between the user U and the pause adviser system PAS is required, a short soft flash may be used before the sound to prevent the user U from getting a shock.

One example of a sub-output arrangement O1 of the output arrangement OA is a transducer such as a speaker which is capable of transforming a representation of the output advice data OAD into an audio signal such as tones, talking voice, etc. The speaker may communicate predetermined sound sequences which are stored in the data storage circuitry DSC and the intensity of these sound sequences may, depending on the purpose e.g. advice or alarm, be up to and over 90 dB.

Another example of a sub-output arrangement O2 of the output arrangement OA is an illuminator which is capable of transforming a representation of the output advice data OAD into light. Such illuminator is preferably a LED (LED; Light Emitting Diode) but may also create light based on e.g. short arc gap, wolfram thread, fiber or optics or other technologies. The illuminator is preferably communicating predetermined light sequences stored in the data storage circuitry DSC e.g. in combination with predetermined sound sequences.

Further examples of a sub-output arrangement On of the output arrangement OA may be arrangements creating vibration, heat, cold, etc.

The user input arrangement IA enables the user U to provide user input data UID to the pause adviser system PAS. Through the user input arrangement IA the user U is capable of interacting with the pause adviser system PAS, e.g. respond to an advice from the pause adviser system PAS or adjusting the current fatigue level CF as described below. Another use of the user input arrangement IA is to load information to the pause adviser system PAS, e.g. loading a personal user profile PUP to the pause adviser system PAS, which is needed for the pause adviser system PAS to operate user specifically as described below.

One example of a sub-user input arrangement I1 of the user input arrangement IA is a transducer such as a microphone which is capable of registering and transforming the voice of the user U into user input data UID. Furthermore, a microphone may record background noise and with such user input data UID it is possible to adjust the volume of advises from the output arrangement OA relative to the background noise.

Another example of a sub-user input arrangement I2 of the user input arrangement IA is a touch panel. With a touch panel it is possible for the user to communicate e.g. adjust or respond the pause adviser system PAS only by touching, which does not require notable attention from the user U.

Further examples of a sub-user input arrangement In of the user input arrangement IA may be mechanical or electric switches or arrangements for receiving data e.g. wireless data communication.

Furthermore, it should be noted that in an embodiment of the invention where data communication is possible or where the pause adviser system PAS comprises a microphone, the user U may load or save his own sound and light sequences to the the pause adviser system PAS.

The sensor input arrangement SI of the pause adviser system PAS is providing information of the environment in which the pause adviser system PAS operates. This information may be relevant for the fatigue level FL of the user U.

One example of a sensor S1 of the sensor input arrangement SI is a light sensor for transforming the light intensity, e.g. inside a car or an office, into sensor input data SID for use in the estimation of the user's U fatigue level FL. Such light sensor S1 may e.g. be optical detectors, photodiodes, photoresistors, etc.

Another example of a sensor S2 of the sensor input arrangement SI is a vibration sensor for transforming vibrations or motions, e.g. of a dashboard of a car, into sensor input data SID for use in the estimation of the user's U fatigue level FL. Such vibration sensor S2 may e.g. be an accelerometer.

Yet another example of a sensor Sn of the sensor input arrangement SI is a touch sensor for transforming e.g. the touch of a user U into sensor input data SID for use in the estimation of the user's U fatigue level FL. Such touch sensor Sn may e.g. be based on capacitive, resistive or infrared technologies. It should be noted that other technologies than the mentioned also may be used.

The data storage circuitry DSC of the pause adviser system PAS is intended for storing data or a representation of data such as the reference data RD, input user data IUD received by the user input arrangement IA, sensors input data SID received by the sensor input arrangement SI, etc.

The reference data RD may both represent data obtained by or provided to the pause adviser system PAS, e.g. during an ongoing trip in a car, provided to the pause adviser system PAS by the user U before the trip starts and scientific information of general conditions affecting the fatigue level FL of a user U.

Data from each of these categories of data may be used by the pause adviser system PAS when estimating the fatigue level FL of a user U.

The timer arrangement TA, of the pause adviser system PAS, provides a time domain to the estimation of the fatigue level FL. The timer arrangement TA may e.g. be a digital timer or clock signal from which it is possible to derive e.g. year, month, day and/or time of the day. This may according to an embodiment of the invention be possible either when the pause adviser system PAS is in use, in standby or turned off.

The data processor DP may be used in the pause adviser system PAS for calculating the fatigue level FL of the user U based on the above-described user input data UID, sensor input data SID, reference data RD and time data TD. Furthermore, the data processor DP may be responsible for the saving, communicating and processing of data within the pause advisor system PAS and communication with the surroundings. The power unit PU is supplying the pause adviser system PAS with energy from an energy source such as a battery or generator.

The communication between the illustrated elements of the pause adviser system PAS is illustrated as going through the data processor DP, but this is only one of a plurality of ways of connecting the different elements of the pause adviser system PAS.

Furthermore, it should be noted that it is possible to include further elements to the pause advise system PAS if necessary according to a specific use.

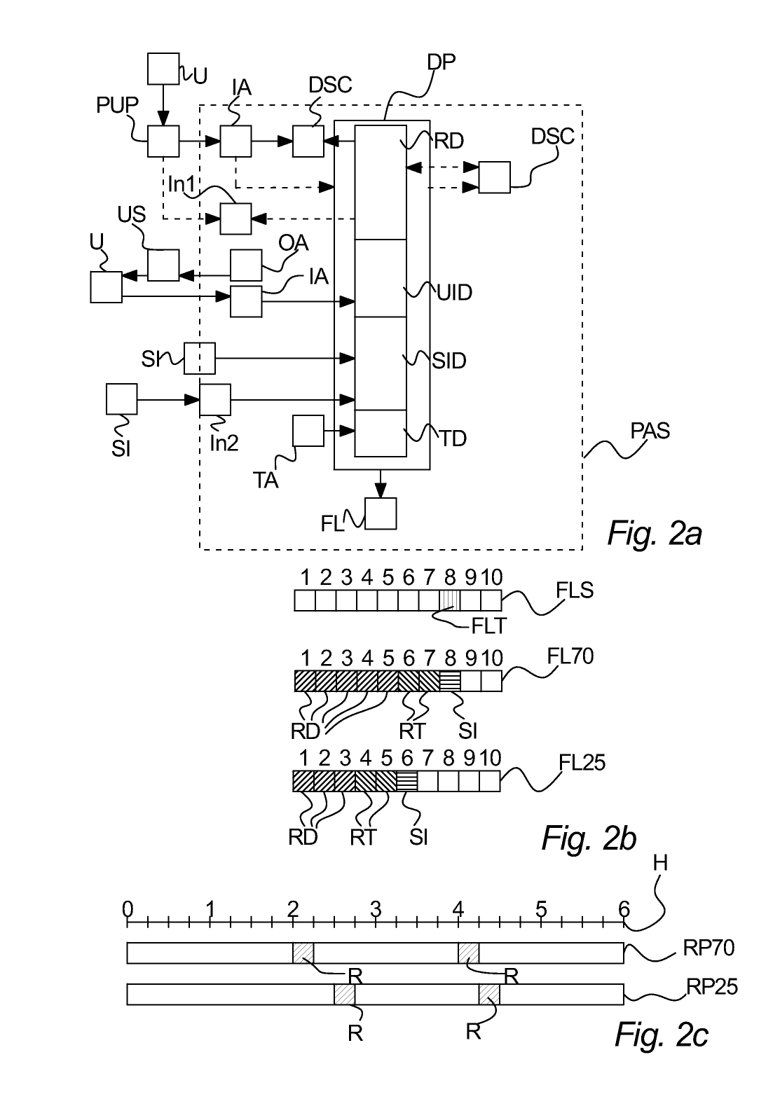

FIG. 2a-2c illustrate one way of using the pause adviser system PAS and estimating the fatigue level FL of the user U. It is common knowledge that humans need to rest and that at the end of long day of work a person feels more fatigued if the person has not rested during the day, compared to a person who has rested during the day. It is scientifically shown that a person's optimal rest pattern RP i.e. frequency and length of the rests during a work- or drive sequence, among other things, depends on the physical conditions of the person. The other things which affect the rest pattern RP are e.g. time of the day, length of the sequence, ambient light conditions, length of a break, etc.

Consequently, a 70 year old person weighing 110 kg driving 6 hours during the night has a different rest pattern RP during the 6 hour's drive, than a 25 year old person weighing 70 kg. FIG. 2b illustrates how the pause adviser system PAS estimates theses two persons' fatigue level FL differently and FIG. 2c illustrates how the pause adviser system PAS advises these two persons of their different optimal rest patterns RP during the same drive.

FIG. 2a illustrates one conceptual use of the pause adviser system PAS and should therefore not be considered as limiting for the scope of the invention. The illustrated use is the same no matter the age and gender of the user U. The user U provides a personal user profile PUP to the pause adviser system PAS e.g. to a data storage circuitry DSC via the user input arrangement IA. Alternatively, the personal user profile PUP may via a data processor DP be stored in the data storage circuitry DSC or if the user input arrangement IA e.g. comprises a mechanical sub-user input arrangement In1, the personal user profile PUP is mechanically stored.

The data processor DP then retrieves data e.g. represented by the reference data RD from the data storage circuitry DSC matching the personal user profile PUP. This reference data RD is then used in the estimation of the fatigue level FL of the user U.

To estimate the fatigue level FL user input data UID such as information of response time RT of the user's U response to user stimuli US communicated to the user U from the output arrangement OA is needed.

Furthermore, sensor input data SID such as information of ambient light conditions is needed. This sensor input data SID is obtained from sensor input arrangement SI which may be located partly within and partly outside the pause advisor system PAS.

A sensor input arrangement SI may also be located apart form the pause adviser system PAS. From the remote location, in relation to the user U or pause advisor system PAS, the remote sensor input arrangement SI communicates sensor input data SID to a sub-user input arrangement In2 and from here it is used in the estimation of the user's U fatigue level FL. This sensor input data SID may e.g. be communicated via wireless data communication such as Bluetooth or other wireless communication means and protocols.

Furthermore, the timer arrangement TA provides time data TD to the estimation of the fatigue level FL or the user U. The timer arrangement TA may e.g. be a GPS

(GPS; Global Position System), atomic timer, high precision clock, etc. from the timer arrangement TA the time data TD may be obtained directly or it may be derived from a signal from the timer arrangement TA.

It should be noted that the timer arrangement TA or other elements of the pause adviser system PAS may be supplied with power from a separate power source dedicated to energize the timer arrangement TA or the other element.

From the time data TD, sensor input data SID, user input data UID and reference data RD it is possible to estimate the fatigue level FL of a user U and thereby estimate the optimal rest pattern RP of the user.

FIG. 2b is a simplified and explanatory illustration of the how the pause adviser system PAS estimates the fatigue level FL70 of a 70 year old user U and the fatigue level FL25 of a 25 year old user U. In this example the users U need to rest when the fatigue level FL reaches a fatigue level threshold FLT at 8 out of 10 on a fatigue level scale FLS.

When the 70 year old user U has loaded his personal user profile PUP, the pause adviser system PAS retrieves data e.g. represented by the reference data RD from the data storage circuitry DSC, matching the specific personal user profile PUP. The reference data RD matching the personal user profile PUP of the 70 year old user U adds an offset of 5 to the fatigue level FL70.

The response time RT, of the 70 year old user U to the user stimuli US of the response test performed by the pause advisor system PAS adds a further contribution of 2 to the fatigue level FL70, because the 70 year old user's U response time RT was not convincingly fast. If the reaction time RT was as fast as expected, the reaction time RT would not have contributed to the fatigue level FL75.

The last contribution to the fatigue level FL70 in this example is provided by the sensor input arrangement SI, because the user drives at dark night, the sensor input arrangement SI adds a further contribution of 1 to the fatigue level FL70.

Therefore, the 70 year old user U needs to rest because the total of contributions to the fatigue level FL70 is 5+2+1=8, which equals the fatigue level threshold FLT.

Still according to FIG. 2b, the fatigue level FL25 of the 25 year old user U is also offset by data represented by the reference data RD related to the personal user profile PUP of the 25 year old user U. But because of the difference in age the offset on the fatigue level FL25 from the reference data RD related to the 25 year old user U is only 3.

The reaction time RT of the 25 year old user U is similar to the reaction time RT of the 70 year old user; hence, the reaction time RT contributes with 2 to the fatigue level FL25.

The 25 year old user's U drive is also at dark night; hence, the sensor input arrangement SI contributes with 1 to the fatigue level FL25.

Therefore, the total fatigue level FL25 of the 25 year old user U is 3+1+2=6, accordingly the 25 year old user U still has not reached the fatigue level threshold FLT at 8 and may continue without being advised to rest by the pause adviser system PAS.

Since the response time RT of the 25 year old user U were slower than expected from a 25 year old user U, it was comparable with the response time RT of the 70 year old user U, the pause adviser system PAS is going to test the response time RT of the 25 year old user with a relative high frequency. This is done to test if the slow response time RT was an event only occurring once or if the response time RT is slow in successive reaction tests, which could indicate that the user U is tired and needs rest. In the latter case this will be communicated to the user U by the pause adviser system PAS.

FIG. 2c illustrates a typically rest pattern RP70, PR25 from a 70 and a 25 year old user U respectfully, relative to a time line H divided in hours from 0 to 6 hours.

The rest pattern RP70 of a 70 year old user U illustrates the need of a rest R after a first drive sequence of 2 hours while the rest pattern RP25 of a 25 year old user U illustrates the need of a rest R after a first drive sequence of 2.5 hours.

The illustrated rest patterns RP70 and RP25 are only used to illustrate that differences occurs e.g. because of age of the user U. Of course, since a lot of different data is used to calculate or estimate the fatigue level FL, these rest patterns RP70, RP25 differs from person to person.

Furthermore, it should be noted that the rest patterns RP70, RP25 are the optimal rest patterns to the specific user U, advised by the pause adviser system PAS. The users U are free to rest R before it is advised by the pause adviser system PAS. Such a not advised rest R (not illustrated) is taken into account in the estimation of the fatigue level FL when the drive continues.

Furthermore, is should be noted that the intervals between the rest R in the rest pattern RP25 are not of the same duration. Firstly, this is because data represented by the reference data RD prescribes that a second sequence should be shorter than a first sequence, but the reason could also be that the user's U response time RT to a user stimuli US is slow, indicating that the user U needs a rest R.

Furthermore, it should be noted that if one of the users U feels fit he may snooze the advised rest R, to arrive at the destination sooner. In this way the user U may continue driving as before while overruling the advice from the pause adviser system PAS.

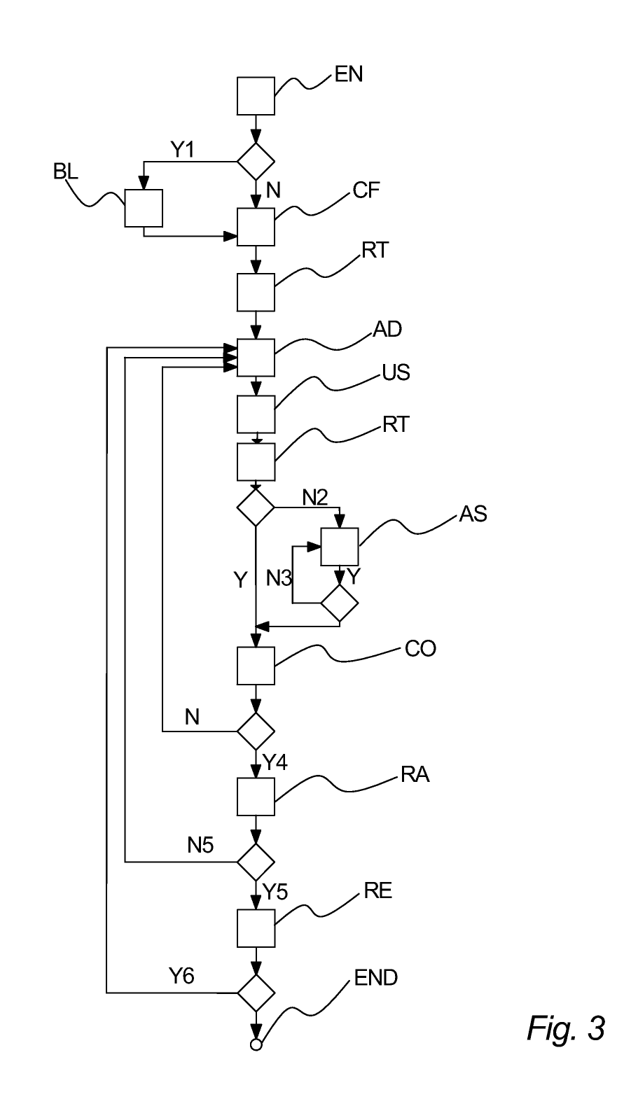

FIG. 3 illustrates a flow chart describing a preferred use of the invention where the pause adviser system PAS is integrated in a portable stand alone device and the invention should therefore not be understood as limited to the description of FIG. 3. Before using the pause advising system PAS it has to be energized EN, preferably from one or more batteries such as AAA batteries installed in the power unit PU. When energized the pause adviser system PAS it is ready for use.

Firstly, the user U needs to decide whether or not the pause adviser system PAS has to be provided with a personal user profile PUP. A baseline BL configuration is recommended because it enables the pause adviser system PAS to estimate the fatigue level FL of the user U more accurately.

If it is chosen to perform the baseline BL configuration Y1, a personal user profile PUP describing the physiological conditions of the user U e.g. in terms of age, weight, gender, etc. is created and loaded to the pause adviser system PAS via the user input arrangement IA.

This personal user profile PUP categorizes the user U in one of a number of predefined categories which in the pause adviser system PAS is used as an offset in the estimation of the fatigue level FL of the user U. An old user with a high BMI (BMI; Body Mass Index) statistically belongs to a category which, e.g. when driving a car, more often needs a break than a young user with normal BMI. With the personal user profile PUP provided to the pause adviser system PAS, the pause adviser system PAS requires interaction more frequently from the old user having a high BMI than from the young user having a normal BMI.

It is at any time possible to perform a current fatigue level adjustment CF using the user input arrangement IA. If the user U of the pause adviser system PAS e.g. before or during a drive feels more tired than usual, the current fatigue level adjustment CF can be used to add an offset to the pause adviser system PAS. This offset adjustment is taken into account when the pause adviser system PAS estimates the fatigue level FL and will e.g. require more frequent interaction between the user and the pause adviser system PAS.

The current fatigue level adjustment CF may of course also be used reversed in case the user feels more fit than usual and therefore does not need to rest as frequently as usual.

When the offset from the baseline BL and the current fatigue level adjustment CF is provided to the pause adviser system PAS, the pause adviser system PAS needs reference information of the response time RT of the user U. The pause adviser system PAS obtains this reference information of the users U by one or more random tests preferably early in e.g. a drive sequence to obtain reference information from the user, when the user is still focused on the drive. A random test may e.g. be performed by means of light or sound from the output arrangement OA to which the user U response via the user input arrangement IA e.g. by touch or voice recognition.

During use of the pause adviser system PAS e.g. during a drive, the pause adviser system PAS continuously acquire data AD describing e.g. duration of the drive, vibrations, time of day, response time RT to reactions tests, etc. This acquired data AD is by the pause adviser system PAS correlated with the baseline BL, actual AC and reaction test information, to estimate the user's U fatigue level FL and thereby the optimal time for the user's U next rest.

The user's response time RT to user stimuli US from the output arrangement OA is continuously tested. The output arrangement OA of the pause adviser system PAS communicates user stimuli US such as a test signal, e.g. one or more illuminators lights up and/or a speaker makes a sound. The time from the test signal is activated by the pause adviser system PAS to a respond from the user U is registered is then measured by the pause adviser system PAS.

If the user U does not respond N2 by activating the user input arrangement IA an alarm signal AS, preferably a sound, increases significantly and the sound may continue to increase ending in an alarm if the user U does not respond N3 by activating the user input arrangement IA. The alarm is reset e.g. if the input arrangement IA is activated.

After a sequence where the user U did not respond appropriately to the user stimuli US, the user U is tested again within a short period of time e.g. within 3 minutes.

The response time RT of the driver is measured and indicates or reflects the fatigue level FL of the user U and is used in the pause adviser system PAS to determine when the next test of the driver's response time RT is performed.

Furthermore, the response time RT of the driver is correlated CO with the information obtained by the pause adviser system PAS as described above. The result of this correlation CO is an estimate of the fatigue level FL of the user U and can be used to estimate when the user U preferably should take the next rest.

If the fatigue level FL based on the above correlation CO of data passes a fatigue level threshold Y4, the output arrangement OA of the pause adviser system PAS advises the user U to rest RA and rest RE. It is now up to the user U to decide how to follow the advice e.g. by instantly Y5 pulling over to rest RE or later N5 if the user U e.g. feels fit or because the user U drives on a highway with no exit near by. In the latter case it is possible to snooze the rest advice RA for a period of time of e.g. 1 to 10 minutes; hence, it becomes possible to drive to the nearest exit and take the break.

If the user U decides to snooze the rest advice RA, the pause adviser system PAS continues to acquire data AD and when the predefined snooze period ends, a new rest advice RA is communicated to the user.

It should be mentioned that there does not have to be a limit on the number of times the user U may use the snooze function. Furthermore, it should be mentioned that during a snooze period the pause adviser system PAS may operate normally as described above.

When the user U pulls over to rest RE, either voluntarily or because the user U has received a rest advice RA by the pause adviser system PAS, it is registered by the sensor input arrangement SI and the length e.g. in minutes of the rest RE may then be determined e.g. by means of the timer arrangement TA.

The pause adviser system PAS then uses information of the length of the rest RE to decrease the remaining time of the advised rest RE. When the advised rest RE is completed the output arrangement OA informs the user U that the fatigue level FL is decreased enough to continue Y6.

If the user U rests without having received a rest advice RA, the measured length of the rest RE is used when the pause adviser system PAS is estimating the time to the next rest advice RA. Hence, the pause adviser system PAS estimates the effect of the voluntary rest RE on the fatigue level FL of the user U and the user U continues the trip with a decreased fatigue level FL.

After a rest RE, whether it is voluntary or not, the drive may be continued and the pause adviser system PAS again starts to acquire data AD, obtain response time RT of the driver, correlated CO data, etc. until the pause adviser system PAS again communicates a rest advice RA to the user U.

It should be noted that because of the fact that the response time RT of the user U is used in the pause adviser system PAS, the time between two following rest advices

RA may not be identical—the longer response time RT, to shorter time between the rest advices RA.

Still according to FIG. 3, if a new driver takes over, the pause adviser system PAS needs to be informed. If the new driver has the same personal user profile PUP as the previous driver, there is no need for a baseline BL configuration, which is contrary to the situation where the two drivers are not represented by the same personal user profiles PUP.

Whether or not the baseline BL configuration is made, the new driver has the same possibilities for interacting with the pause adviser system PAS as described above in relation to the first driver.

It should be mentioned that the drive specific data obtained by the pause adviser system PAS during the drive with the first driver may be reset when the new driver continues the drive. The reset of data may be performed by performing a baseline BL adjustment or by means of interactions between the user and the user input arrangement IA. Such interactions could e.g. be the user U touching the touch panel in a predetermined amount of time, of e.g. 10 seconds, the pause adviser system PAS may then respond to this interaction by a sound or light sequence, to inform the user U that the drive specific data is reset. Furthermore, the pause adviser system PAS is reset for drive specific data after a period of time where the pause adviser system PAS has not been in use, such period could e.g. be 5-10 hours.

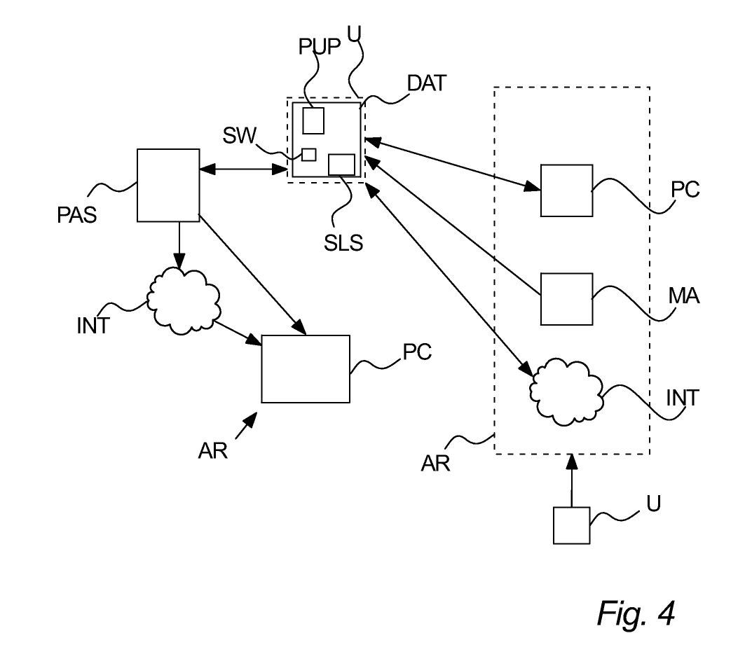

FIG. 4 illustrates the pause advisor system PAS communicating with additional recourses AR such as e.g. a personal computer PC, a manual MA, the internet INT, etc. From one or more of these additional recourses AR the user U may communicate data DAT such as e.g. the personal user profile PUP, sound and light sequences SLS, updates of software SW, etc. to the pause advisor system PAS. The personal user profile PUP can also be made by utilising the additional recourses AR and the user U then manually loads it to the pause advisor system PAS.

In an embodiment of the invention, the pause advisor system PAS may also be able to communicate to the additional recourses AR such as a personal computer PC e.g. via the internet INT. Then the user U may use data obtained by the pause advisor system PAS for statistics, publish in a community on the internet, etc.

It should be noted that according to an embodiment of the invention it is possible to combine features from each of the mentioned figures and embodiments in one pause adviser system PAS.

1.-36. (canceled)

37. A pause advice device, said pause advice device comprising:
a housing,
an input arrangement for receiving input from a user,
an audio source for providing an audio signal,
a display arrangement for providing a visual signal,
an internal clock for keeping track of time,
a data processing unit,
a data storage circuitry for storing data,
a pause algorithm embedded in said data storage circuitry, and
power arrangement for supplying power,
said pause algorithm being adapted to receive input from the input arrangement,
said input arrangement being adapted to receive input in the form of a personal user profile,
said input arrangement being adapted to provide information to said pause algorithm to start-up calculation of a fatigue level of said user,
said pause algorithm being adapted to receive said personal user profile from the input arrangement,
said pause algorithm being adapted to provide user stimuli via said display arrangement and/or via said audio source,
said pause algorithm being adapted to receive response input from a user based on a user's response to said user stimuli provided via said display arrangement and/or via said audio source,
said pause algorithm being adapted to provide an alarm signal via said display arrangement and/or via said audio source, said alarm signal signaling preferred time for said user for resting according to said pause algorithm,
said alarm signal being provided at least on the basis of said response input and on said personal user profile.

38. The pause advice device according to claim 37, wherein said input arrangement (IA) being adapted to receive current fatigue level from said user.

39. The pause advice device according to claim 37, wherein said pause algorithm being adapted to determine a fatigue level of a user based on said personal user profile.

40. The pause advice device according to claim 39, wherein said pause algorithm being adapted to determine a fatigue level of a user additionally based on said current fatigue level and characteristics of said response input.

41. The pause advice device according to claim 37, wherein said pause algorithm is configured for provide user stimuli and receive response input repeatedly at intervals wherein said intervals being determined on the basis of said fatigue level of the user.

42. The pause advice device according to claim 37, wherein said pause advice device comprises a data storage circuitry comprising reference data used by the pause algorithm to interpret the personal user profile.

43. The pause advice device according to claim 37, wherein said personal user profile can be established by means of additional resources external to said pause advice device.

44. The pause advice device according to claim 37, wherein said alarm signal is an advice to said user of the preferred time for resting and wherein said preferred time for resting occurs when said fatigue level (FL) reaches a fatigue level threshold (FLT).

45. The pause advice device according to claim 37, wherein said pause advice device being adapted to communicate to said user when said rest is over via said display arrangement and/or via said audio source.

46. The pause advice device according to claim 37, wherein said input arrangement comprises a motion sensor for measuring movement of said pause advice device initiating said pause algorithm.

47. The pause advice device according to claim 37, wherein said housing encapsulates said pause advice device and at least one further application.

48. The pause advice device according to claim 47, wherein said further application is a dashboard of a car.

49. The pause advice device according to claim 47, wherein said further application is an application of a car.

50. The pause advice device according to claim 47, wherein said further application is a smartphone.

51. The pause advice device according to claim 47, wherein said further application is a handheld GPS.

52. The pause advice device according to claim 47, wherein said data processor unit, said motion sensor, said display arrangement, said audio source, said input arrangement, said internal clock and said power supply may be shared between said pause advice device and said further application.

53. The pause advice device according to claim 37, wherein an output/input arrangement facilitates download and/or upload of data between said pause advice device and an external device, such as a PC, a smart phone or the like.

54. The pause advice device according to claim 37, wherein said pause advice device facilitates that said motion sensor provides acceleration information relating to situations of being accelerated or decelerated in a direction parallel to a forward direction of movement, and/or in a direction perpendicular to said forward direction of movement in the horizontal plane of movement and/or in a direction perpendicular to said forward direction of movement in the vertical plane of movement, or in any combination of such movements, thereby providing information relating to the degree of monotony of said movement of said pause advice device, wherein said pause algorithm being adapted to receive said input in the form of said acceleration information, and wherein said pause algorithm is adapted to calculate said fatigue level on the basis of inter alia said acceleration information.

55. The pause advice device according to claim 54, wherein said pause algorithm (PA) being adapted to delay, in a predetermined amount of time, the provision of a user stimuli and/or an alarm signal occasioned on the basis of information not relating to acceleration information in a situation in which the acceleration information, that is being provided to the pause algorithm (PA), indicates that a predefined acceleration is encountered in direction parallel to a forward direction of movement, and/or in a direction perpendicular to said forward direction of movement in the horizontal plane of movement and/or in a direction perpendicular to said forward direction of movement in the vertical plane of movement, or in any combination of such movements, thereby indicating that a non-monotony movement of the pause advice device (PAD) taking place, and thereby avoiding interaction with the user in a difficult driving situation, to minimize any distracting elements from the pause advise device.

56. A multifunctional device comprising a pause advice device and one or more further applications, which pause advice device comprising:
a housing,
an input arrangement for receiving input from a user,
an audio source for providing an audio signal,
a display arrangement for providing a visual signal,
an internal clock for keeping track of time,
a data processing unit,
a data storage circuitry for storing data,
a pause algorithm embedded in said data storage circuitry, and
power arrangement for supplying power,
said pause algorithm being adapted to receive input from the input arrangement,
said input arrangement being adapted to receive input in the form of a personal user profile,
said input arrangement being adapted to provide information to said pause algorithm to start-up calculation of a fatigue level of said user,
said pause algorithm being adapted to receive said personal user profile from the input arrangement,
said pause algorithm being adapted to provide user stimuli via said display arrangement and/or via said audio source,
said pause algorithm being adapted to receive response input from a user based on a user's response to said user stimuli provided via said display arrangement and/or via said audio source,
said pause algorithm being adapted to provide an alarm signal via said display arrangement and/or via said audio source, said alarm signal signaling preferred time for said user for resting according to said pause algorithm,
said alarm signal being provided at least on the basis of said response input and on said personal user profile.

57. Means of transportation such as a vehicle, vessel or a plane comprising a pause advice device according to claim 37.

58. Means of transportation such as a vehicle, vessel or a plane comprising a multifunctional device according to claim 56.
